(19) United States
(12) Patent Application Publication
(10) Pub. No.: US 2002/0188435 A1
(43) Pub. Date: Dec. 12, 2002

(54) Interface for submitting richly-formatted documents for remote processing

(75) Inventor: Matthew R. Labarge, Kirkland, WA (US)

Correspondence Address: MERCHANT & GOULD P.C., P.O. Box 2903, Minneapolis, MN, 55402-0903, US

(73) Assignee: Microsoft Corporation

(21) Appl. No.: 09/876,361

(22) Filed: Jun. 7, 2001

(51) Int. Cl. G06F 17/20

(52) U.S. Cl. 704/1

(57) ABSTRACT

An application programming interface (API) for submitting a richly-formatted text selection or document to a remote machine translation server for translation is provided. A software application program, such as a word processor, requests from a redirector server, the uniform resource locator (URL) of a remote machine translation server. All formatting, images, including pictures, drawings and the like, and other data objects not requiring translation are saved in a temporary file. The word processing software application opens an instance of an Internet browser, and the Internet browser submits the text selection to the remote machine translation server via the Internet, an intranet, or other distributed computing environment. The machine translation server translates the text selection and returns the translated text selection to the Internet browser at the client level. The translated text selection is displayed as a by the Internet browser, and all formatting contained in the original pre-translated document is maintained. Images and data objects not requiring translation, and previously saved in a temporary file on the user's computer are displayed with the translated text in the same positions and order as they were in the pre-translated document.

### TECHNICAL FIELD

The present invention relates to application programming interfaces and, more particularly, the present invention relates to an application programming interface for submitting documents for remote processing, including remote translation services.

### BACKGROUND OF THE INVENTION

Since the dawn of communication, it has been necessary to translate written and spoken language across a number of languages to facilitate commerce as well as everyday communication. With the advent of the Internet, e-commerce, and advance word processing, the need for a fast and efficient language translation has increased dramatically. In a typical setting, a user receives a document written in a language other than the language understood by the user, and the user must obtain at least some basic translation of the document in order to determine the document's relevance and importance to the user. At the most basic level, the user may translate the document one word at a time using a translation dictionary, or the user may send the document to a human translator to have the document translated in part or in whole. Human translation is both time consuming and expensive, and where the user only needs a quick review of the document in question, such time consuming and expensive human translation is inefficient, if not unnecessary together.

Systems have been developed for electronically translating a text selection or document from one language to another. Such systems, often referred to as machine translation systems, may be utilized in the form of a software application resident on a user's computer, or such systems may be resident on a remote server accessible to a user via the Internet or other distributed computing environment.

Machine translation systems resident on the user's computer suffer from resource limitations, including memory and disk space required for large translation dictionaries and the ability to easily update the machine translation software with improvements and modifications. Machine translation systems resident on the user's computer and machine translation system resident on a remote server also suffer limitations related to the submission of the text or document to the machine translation system. For example, typically a document submitted to prior art machine translation systems are translated into the desired language, but are returned to the user without the formatting that was applied to the original document. For example, if a document contains tables, indentations, margin settings, etc., those formatting characteristics are typically lost in the translation processing. Text selections or documents returned to the user without the original formatting may be readable insofar as the returned text selection or document is in the language understood by the user, but the text selection or document may be incomprehensible to the user because the loss of formatting alters the context of the words in the text selection or document.

Additionally, submission of a text selection or document to prior art machine translation systems typically requires the user to copy and past a text selection or document into a user interface provided by the machine translation system whether the system is resident on the user's computer or whether the system is resident on a remote server.

It is with respect to these considerations and others that the present invention has been made.

### SUMMARY OF THE INVENTION

In accordance with the present invention, the above and other problems are solved by an application programming interface (API) for submitting a richly-formatted text selection or document to a remote machine translation server for translation. The user's software application program, such as a word processor, requests from a redirector server the uniform resource locator (URL) of a remote machine translation server. All formatting, images, including pictures, drawings and the like, and other data objects not requiring translation are saved in a temporary file on the user's computer. The user's word processing software application opens an instance of the user's Internet browser, and the Internet browser submits the text selection to the remote machine translation server via the Internet, an intranet, or other distributed computing environment.

The machine translation server translates the text selection and returns the translated text selection to the Internet browser of the user's computer. The translated text selection is displayed as a Web page via the user's Internet browser, and all formatting contained in the original pre-translated document is maintained. Images and data objects not requiring translation, and previously saved in a temporary file on the user's computer are displayed with the translated text in the same positions and order as they were in the pre-translated document.

More particularly, the API includes a method and system for receiving a pre-translated document requiring translation from a first language to a second language and selecting a translation service from a list of services for translating the pre-translated document from the first language to the second language. The pre-translated document, including any non-text entries from the pre-translated document is saved to a temporary storage medium. A saved document is created from the pre-translated document in a format for submitting to the selected translation service, the saved document including the formatting of the pre-translated document and including paths to the non-text entries saved in the temporary storage medium. Preferably, the saved document is created in HTML format including tags to formatting of the pre-translated document and tags to the non-text entries saved to the temporary storage medium. The saved document is submitted to the selected translation service via the identification for the selected translation service. Preferably the saved document is submitted to the selected translation service at a remote translation server via a distributed computing environment.

At the selected translation service, a translated document is created by translating the saved document from the first language to the second language. The translated document is returned from the translation service and is displayed using the paths to the non-text entries saved in the temporary storage medium to call the non-text entries, and the translated document is displayed with the non-text entries and formatting of the pre-translated document.

According to another aspect, a method of communicating between a client process and a server process in a distributed processing system is provided for providing remote translation processing for richly-formatted documents. The client process issues an HTTP GET request call having a plurality of call parameters, comprising a translation service identifier, a “from” language identifier and a “to” language identifier. A first server process receives the HTTP GET request call and parses the call to retrieve the parameters. The first server process issues an HTTP GET request acknowledgement having a uniform resource locator (URL) of a second server process.

The client process then issues an HTTP POST request call having a plurality of call parameters comprising a translation service identifier, a user interface language identifier, a “from” language identifier and a “to” language identifier, and further comprising a data body including an HTML formatted document including tags for document formatting and tags linking the HTML formatted document to non-text images saved to a temporary storage medium, the HTML formatted document requiring translation from the “from” language to the “to” language. The second server process receives the HTTP POST request call and parses the call to retrieve the parameters. The second server process issues an HTTP POST request acknowledgement having a plurality of acknowledgement parameters including, a user interface language identifier, a “from” language identifier, a “to” language identifier, and the HTML formatted document translated from the “from” language to the “to” language and represented in HTML format.

These methods may be implemented as a computer process, a computing system or as an article of manufacture such as a computer program product or computer readable media. The computer program product may be a computer storage medium readable by a computer system and encoding a computer program of instructions for executing a computer process. The computer program product may also be a propagated signal on a carrier readable by a computing system and encoding a compute program of instructions for executing a computer process.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention, as claimed.

### BRIEF DESCRIPTION OF THE DRAWINGS

FIG. 1 illustrates a computer system that provides an operating environment for an exemplary embodiment of the present invention.

FIG. 2 is a block diagram illustrating the system architecture of an exemplary embodiment of the present invention.

FIG. 3 is a block diagram illustrating the relationship between an operating system registry, a word processing application and an Internet browser according to an exemplary embodiment of the present invention.

FIG. 4 illustrates an operational flow of the steps performed by the system and method of the present invention.

### DETAILED DESCRIPTION OF THE PREFERRED EMBODIMENT

In accordance with an exemplary embodiment of the present invention, an application programming interface (API) is provided which contains a set of routines that may be used by a software application program, such as a word processor, to direct a richly-formatted text selection or document to a remote server for remote processing, such as sending a document to a remote machine translation server for translation services. The user's word processing software application requests from a redirector server the uniform resource locator (URL) of a remote machine translation server. A text selection or document to be translated is saved in a suitable language or format, such as hypertext markup language (HTML), and non-text entries, such as images, drawings, pictures, and other data objects not requiring translation are saved in a temporary file on the user's computer. The word processing software application opens an instance of an Internet browser, and the Internet browser submits the text selection or document to the remote machine translation server via a distributed computing environment, including the Internet, an intranet or the like.

The machine translation server translates the text selection and returns the translated text selection to the Internet browser of the user's computer. The text selection in the translated language is displayed to the user via the Internet browser in the original formatting, and all images and other data objects not requiring translation are displayed in the proper locations and order relative to the translated text as they were positioned in the original text selection.

The API of the present invention may also be used to send text or data to a remote server for other types of processing where the original formatting and original non-text or non-data entries, such as images, drawings, pictures, and the like are preserved in the post-processed text or data. For example, a document including data requiring remote mathematical processing may be sent to a remote server for such processing. If the data is formatted in a certain manner, including tables, equations, etc., the API of the present invention may be used to send the data for remote processing while keeping the formatting preserved for the return data from the remote processor.

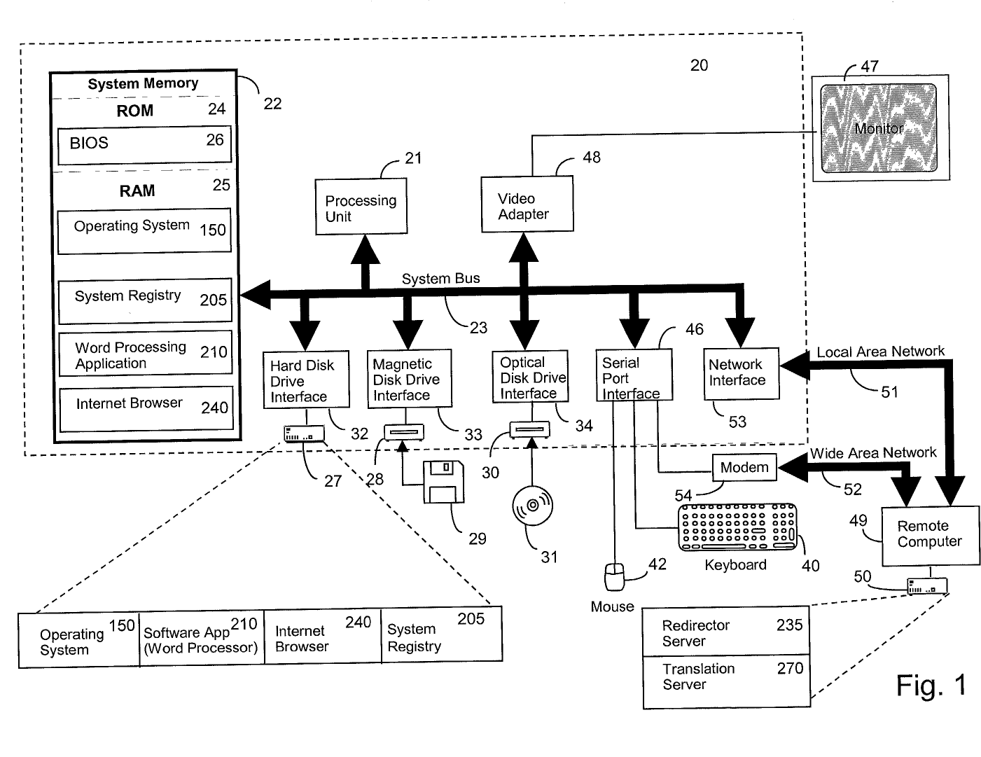

FIG. 1 and the following discussion are intended to provide a brief, general description of a suitable computing environment in which the invention may be implemented. While the invention will be described in the general context of an application program that runs on an operating system in conjunction with a personal computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 1, an exemplary system for implementing the invention includes a conventional personal computer 20, including a processing unit 21, a system memory 22, and a system bus 23 that couples the system memory to the processing unit 21. The system memory 22 includes read only memory (ROM) 24 and random access memory (RAM) 25. A basic input/output system 26 (BIOS), containing the basic routines that help to transfer information between elements within the personal computer 20, such as during start-up, is stored in ROM 24. The personal computer 20 further includes a hard disk drive 27, a magnetic disk drive 28, e.g., to read from or write to a removable disk 29, and an optical disk drive 30, e.g., for reading a CD-ROM disk 31 or to read from or write to other optical media.

The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage for the personal computer 20. Although the description of computer-readable media above refers to a hard disk, a removable magnetic disk and a CD-ROM disk, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 25, including an operating system 150, a system registry 205, a software application 210, and an Internet browser 240. A user may enter commands and information into the personal computer 20 through a keyboard 40 and pointing device, such as a mouse 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a game port or a universal serial bus (USB). A monitor 47 or other type of display device is also connected to the system bus 23 via an interface, such as a video adapter 48. In addition to the monitor, personal computers typically include other peripheral output devices (not shown), such as speakers or printers.

The personal computer 20 may operate in a networked environment using logical connections to remote computers 49. The remote computer 49 may be a server, a router, a peer device or other common network node, and typically includes many or all of the elements described relative to the personal computer 20, although only a memory storage device 50 has been illustrated in FIG. 1. A number of servers are illustrated as resident on the memory storage device 50 of the remote computer 49, including the Redirector server 235 and the Translation server 270. It should be understood that the remote computer 49 is illustrative of one or more remote computers. Typically, the Redirector server 235 and the Translation server 270 reside on different computers. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the personal computer 20 is connected to the LAN 51 through a network interface 53. When used in a WAN networking environment, the personal computer 20 typically includes a modem 54 or other means for establishing communications over the WAN 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

Computing device, such as personal computer 20, typically includes at least some form of computer readable media. Computer readable media can be any available media that can be accessed by personal computer 20. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by personal computer 20.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Computer readable media may also be referred to as computer program product.

As set forth above, according to an exemplary embodiment of the present invention, an API is provided for use by software applications, such as word processing applications, to locate and communicate with remote machine translation servers for providing translation of text selections from one language to another. According to a preferred embodiment, the API includes a set of routines for use by a software application program to direct performance of procedures by the user's computer operating system for the submission of a text selection to the remote machine translation server for translation. According to a preferred embodiment, the API has three main components including a list of services, a redirection request, and a translation request.

List of Services

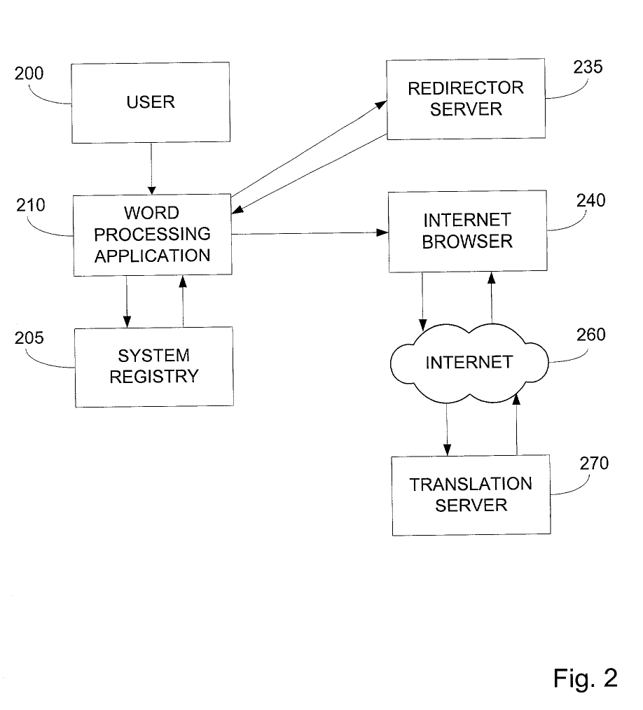

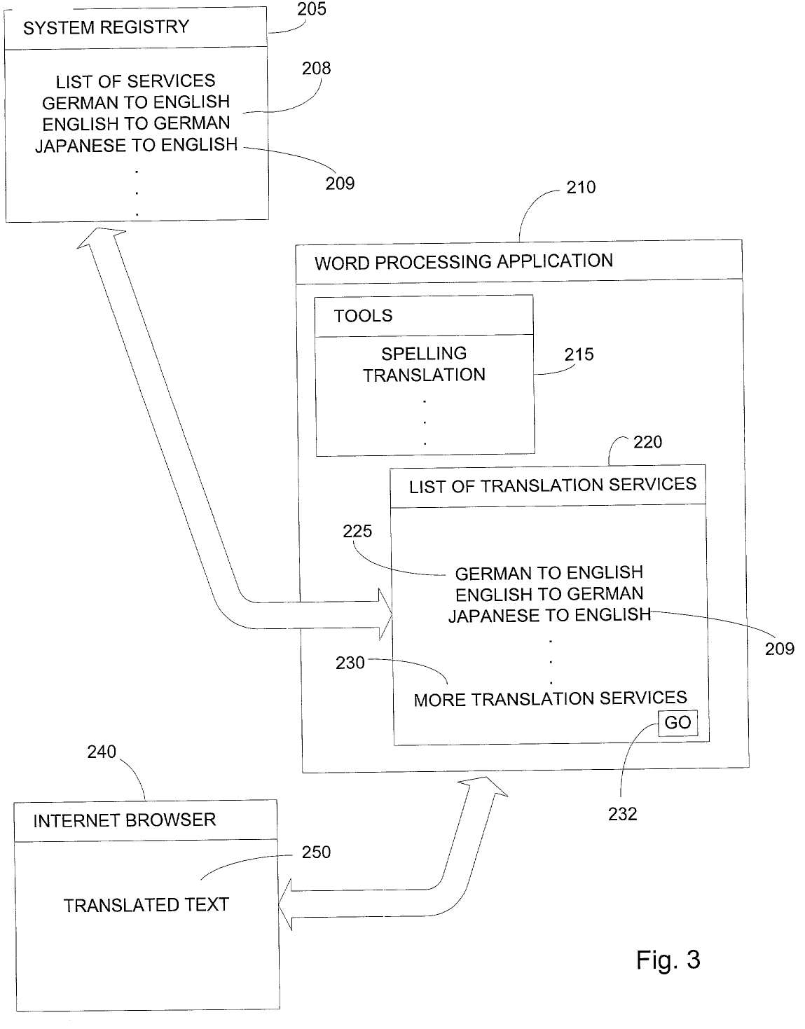

Referring now to FIGS. 2 and 3, a list of translation services 208 is stored in the system registry 205 of the operating system 150 of the user's computer 20. The list of services 208 is used to populate a drop-down list of translation services 220 from which the user may choose the service the user wishes to use for translating a given text selection. According to a preferred embodiment, the list of services includes translation services available to the user for translating text selections, and each service contained within the list of services, such as the “Japanese to English” service 209, illustrated in FIG. 3, consists of a unique service identifier, a “from” language and “to” language, a translation service provider name, and a URL to use as a redirector for the service.

The unique service identifier and provider name identify the actual machine translation service for providing a given translation service. For example, the “Japanese to English” service 209 may be provided by a given translation company server. The URL for use as a redirector for the service is utilized by the API for locating and communicating a redirector server 235 for providing URLs of machine translation servers containing the functionality of the machine translation service providers.

According to a preferred embodiment, the functionality of the API is utilized by a word processing software application with which the user displays, review, and edit a given text selection or document. An exemplary word processing software application is Word®, manufactured by Microsoft Corporation of Redmond, Wash.

In one embodiment, the list of services 208 contained in the system registry 205 may be populated with a default list of services designated by the developer of the word processing application. Preferably, the list of services 208 is populated and updated by downloading the list to the system registry 205 from time to time. That is, the first time the user desires the services of the translation API, the user selects the “More Translation Services” command 230 of the list of translation services 220 drop-down menu under the tools menu of the user's word processing application 210. Selecting the “More Translation Services” command causes a search for and download of available remote machine translation services to the system registry 205 of the user's computer 20.

According to an alternate embodiment, the API may include instructions that cause a periodic search and download of new services into the list of services 208 of the system registry 205. Accordingly, each time the user initiates a new session of the word processing application 210, the list of services 208 in the system registry 205 may be updated with any newly located and downloaded remote machine translation services. Because the user may download additional services using the “More Translation Services” command 230 while the word processing application 210 is running, a registry value may be set as a flag to force the word processing application 210 to reload the list of services 208 from the system registry 205 the next time the user drops down the list of translation services 220, as illustrated in FIG. 3.

Redirection Request

Referring still to FIGS. 2 and 3, once the user selects a translation service, for example, “Japanese to English”, a redirection request is sent from the word processing application 210 to a redirection server 235, as illustrated in FIG. 2. The purpose for the redirection request is to obtain the URL for the particular translation service selected by the user, for example “Japanese to English.” According to a preferred embodiment, the redirection server 235 may be a remote server available for the user via the Internet, or the redirection server 235 may be resident in a intranet or other distributed computing environment to which the word processing application has access through the user's computer 20.

Preferably, redirection provides flexibility for the URL addresses assigned to various machine translation servers. Only the redirection server URL needs to remain constant for access by the word processing application 210, while the machine translation server URLs may be changed from time to time to reflect configuration changes or to reflect changes in available machine translation services. For example, if the ABC Translation Company goes out of business, the URL address for the ABC Translation Company will be removed and/or replaced by the URL of an alternate machine translation service designated for a given translation service, for example, “Japanese to English.”

The redirection request made to the redirection server 235 is an HTTP GET request. As is well known to those skilled in the art, the GET request is a standard command under the file transfer protocol (FTP) or the hypertext transfer protocol (HTTP) for instructing a server to transfer a specified file or information to a client machine. For example, the HTTP GET request for the redirection request of the present invention is used to request from the redirection server a path to a translation page of the machine translation services provider located on a given Web server remote from the user's computer 20.

An exemplary HTTP GET request according to the present invention may take the following form:

http://server/path/file.asp?service=MS-en-ge&lcidFrom=1033&lcidTo=1031

This indicates that the user wants to use the “MS-en-ge” service to translate from English into German. The components of the request are:

http://server/path/file.asp

This is the path to the server file that handles redirection requests.

service=MS-en-ge

This is the unique identifier (a variable-length string) for the translation service chosen by the user, in this example, English to German.

lcidFrom=1033

This is a language identifier that indicates the “from” language for the translation service chosen by the user.

lcidTo=1031

This is a language identifier that indicates the “to” language for the translation service chosen by the user. The text selection or document to be translated is not transmitted as part of this request.

The redirection server responds to the word processing application 210 in plain text with a single line of content, which preferably is in the form:

http://mtserver/mtpath/mtfile.asp

The result of the redirection request is cached in memory for the duration of the current session of the word processing application 210 for performance reasons. Accordingly, if the user requires the same translation services during the present session of the word processing application 210, the word processing application 210 will not need to send an HTTP GET request to the redirection server, but the word processing application 210 will make use of the results of the HTTP GET request that are cached in memory. A new HTTP GET request is performed with each new session of the word processing application 210 to account for updates or modifications to the list of available machine translation service providers and services available to the user and identified via the redirection server 235.

Translation Request

A translation request is made each time the user wishes to perform a translation on a given text selection or document. After the redirector server 235 returns the URL of the translation server 270 for use by the word processing application 210, as described above, the word processing application 210 prepares the text selection for the translation request by saving the current text selection or document in HTML format. According to a preferred embodiment, the text selection is saved as a filtered version of HTML format, whereby any HTML specific coding or tags that are not necessary for the translation process are removed before saving the text selection in HTML format. Saving the text selection in a “filtered” HTML format enhances performance in terms of speed, memory, and processor time.

It should be understood that other language formats may be used to save and submit the text selection to the remote translation server. Indeed, as should be understood by those skilled in the art, any language that may be submitted via the Internet, intranet, or other distributed computing environment from the word processing application 210 to the remote translation server 270 may be used in accordance with the present invention.

According to the preferred embodiment, saving the text selection or document to be translated in HTML format preserves the formatting of the original document. Additionally, temporary files are created in the memory of the user's computer 20 and a representation of the original document and any images or other data objects not be translated are stored therein. The saved HTML version of the text selection or document does not include images or other data objects not to be translated, but includes links to those images and data objects stored in memory on the user's computer 20.

Referring now to FIGS. 2 and 3, after the text selection or document to be translated is saved in the filtered HTML format, it is sent to the translation server 270 for translation. To submit the text selection to the translation server 270, the word processing application 210 invokes an instance of the user's Internet browser 240 and performs an HTTP POST request to the URL of the translation server 270 to provide the translation parameters and the text to be translated. An exemplary Internet browser 240 is Internet Explorer® manufactured by Microsoft Corporation of Redmond, Wash.

As is well known to those skilled in the art, the POST request is similar to the GET request, but the POST request allows a body of data to travel along with the request that would not otherwise fit within the length limitations of the URL. According to a preferred embodiment of the present invention, the POST request includes the URL of the Web page of the translation server 270 on which is provided the translation service desired by the user. The POST request also includes a body of data, referred to as the post data or form data, which includes the HTML formatted text selection for translation. Additionally, the POST request contains parameters regarding the language identifiers that identify the languages at issue for the translation.

An exemplary POST request according to the present invention is as follows:

http://mtserver/mtpath/mtfile.asp?service=MS-en-ge&lcidFrom=1033&lcidTo=1031&lcidUI=1043

The parameters are the same as above, with one additional parameter:

lcidUI=1043

This is an LCID that indicates the user's current user interface language for the application. It is important that the user interface language be designated as a parameter of the request for example, a Dutch user interface, so that any additional content from the translation provider that is returned along with the translated results, such as links to help or advertisement of other translation services, can be provided in the user's preferred user interface language.

Also, the word processing application 210 places the filtered HTML output it has generated for the document into the body of the POST request (normally referred to as the form data.) No supporting files (e.g., images, OLE data, or subdocuments for headers/footers) are transmitted, which speeds up the process of submitting the translation request and reduces the load on the translation server.

The filtered HTML version of the text selection is sent with the POST request by the Internet browser 240 via the Internet 260 to the translation server 270, as illustrated in FIG. 2. At the translation server, the text selection is translated according to the parameters contained in the URL of the POST request. For example, if the translation parameters direct that the text selection is to be translated from English to German, the appropriate translation services resident on the translation server 270, as described above, will translate the text selection from English to German. The translated text selection is maintained in HTML format.

After the text selection has been translated, the translated text selection is returned as a web page via the Internet 260 to the user's Internet browser 240, as illustrated in FIG. 2. As shown in FIG. 3, the translated text is displayed by the user's Internet browser 240. Because the formatting of the original pre-translated document is preserved throughout the translation process, the translated document is displayed on the Internet browser 240 with the same formatting as the pre-translated document. And, all images, including pictures, graphs, charts and other data objects not translated by the functionality of the translation server 270 are immediately displayed by the Internet browser 240 in the same relative positions and orientations as they were in the pre-translated document. As described above, when the original document is saved into HTML format, the original document including images is saved in a temporary file and the HTML format document is populated with file path pointers to the images contained in the original document saved in temporary memory. Advantageously, returning the results of remote processing as a web page allows the provider of the remote processing to add desirable content to the document during processing, such as links to other services like human translation and processing services and advertisements.

Because the Internet browser 240 is invoked to actually perform the POST operation, the server has more flexibility in what it can do to handle the translation request. For example, according to a preferred embodiment of the present invention, if the text selection is one that requires encryption for security purposes, the text selection may be encrypted prior to being submitted to the translation server by the Internet browser 240. After the text selection has been translated by the functionality of the translation server 270, the translated text selection may also be encrypted before being returned to the Internet browser 240 via the Internet 260.

Operation

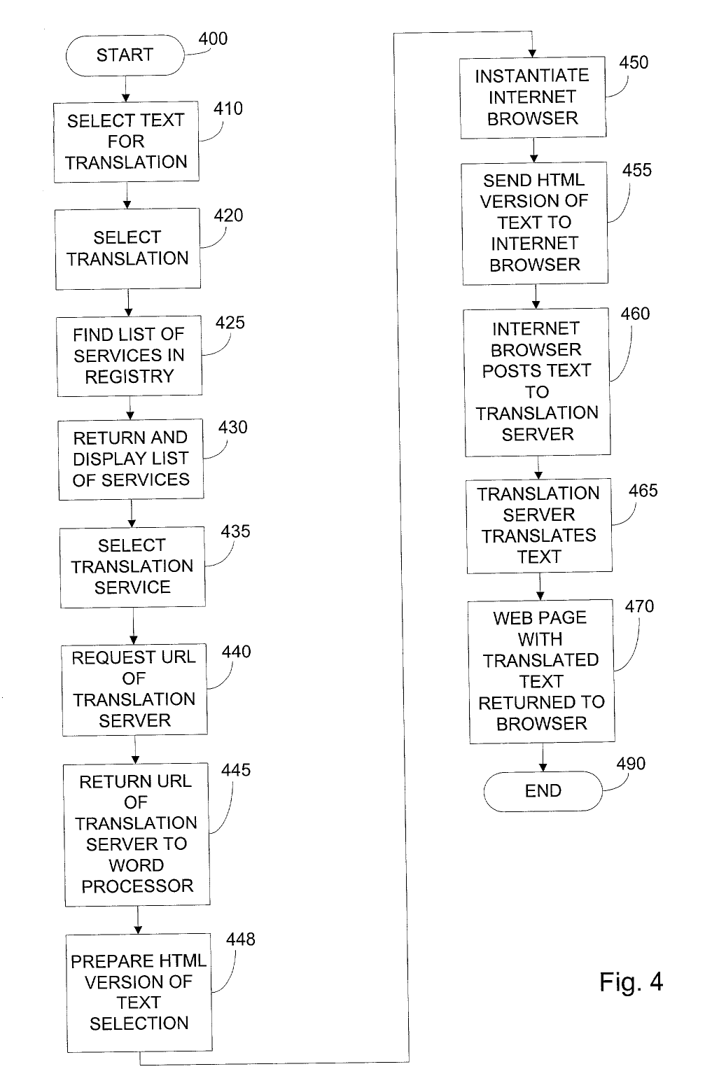

It is advantageous to describe an exemplary embodiment of the present invention in terms of an exemplary operation of the present invention in submitting a richly-formatted text selection to a remote translation service for translation. FIG. 4 illustrates an operational flow of the steps performed by the system and method of the present invention. For purposes of discussion of the operational flow illustrated in FIG. 4, consider as an example that a user of Microsoft Word® word processing application 210 and Internet Explorer® Internet browser 240 receives an e-mail containing a document written in the Japanese language.

The user cannot determine the relevance or importance of the document without a translation of the document. Rather than sending the document to a Japanese-speaking colleague for human translation, or rather than sending the document to a machine translation system that will destroy the formatting of the document, including any embedded images, the user desires the functionality of the translation services of the present invention. The operational flow of FIG. 4 is described with reference to the components illustrated in FIGS. 1-3.

The method begins at step 400, and the user opens for use his word processing application 210 by selecting the document forwarded to the user by e-mail. When the user opens the document using his word processing application 210, the user immediately realizes that the document is written in the Japanese language and contains a number of embedded images, including drawings and pictures.

At step 410, the user selects the entire document for translation. At step 420, the user selects the tools menu 215 of his word processing application 210, and then selects the translation command to open the translations drop-down menu 220, illustrated in FIG. 3. At step 425, selection of the translation button to open the translation dropdown menu 220 causes a retrieval of the list of translation services 208 contained in the system registry 205.

At step 430, the list of translation services 208 are retrieved to the word processing application 210 and are populated into the drop-down menu 220, illustrated in FIG. 3. At step 435, the user locates the “Japanese to English” command 209 and highlights the command. The user then selects the “GO” button 232 to initiate translation of the selected document.

At step 440, the user's word processing application 210 prepares an HTTP GET request in a form similar to that described above containing parameters requesting a URL from the redirection server directed to a translation server that contains the functionality necessary to translate a document from Japanese to English. At step 445, the redirection server 235 returns to the word processing application 210, a URL to the Web page contained on the translation server 270 that has the functionality necessary for translating the selected document from Japanese to English.

At step 448, the word processing application 210 saves the selected document in filtered HTML format. During the process of saving the selected document, the word processing application saves a representation of the document including all embedded images into a temporary memory location. The saved filtered HTML version of the document includes absolute paths linking the HTML document to the images contained in the original document saved in temporary storage.

At step 450, the word processing application 210 opens an instance of the Internet browser 240, as illustrated in FIG. 3. The word processing application 210 sends the HTML formatted version of the selected document to the Internet browser 240.

At step 455, the Internet browser 240 performs an HTTP POST request to the translation server URL provided to the word processing application by the redirector server 235. The HTTP POST request prepared by the Internet browser 240 is in a form similar to that described above and contains parameters designating translation of the selected documents from Japanese to English. Along with the HTTP POST request travels a body of data that contains the HTML formatted version of the selected text document.

At step 460, the Internet browser 240 posts the HTTP POST request along with the HTML formatted document selection to the translation server 270 via the Internet 260, as illustrated in FIG. 2. At step 465, the translation server 270 translates the selected document from Japanese to English. At step 470, a Web page with the translated text is returned to the Internet browser 240 and is displayed as translated text 250 in the text display area of the Internet browser 240, as illustrated in FIG. 3.

As described above, when the Internet browser 240 displays the translated text 250, the paths to the images saved in temporary storage are followed by the Internet browser 240 to retrieve the images into the displayed text at the same relative locations and orientations as the pre-translated document. Accordingly, the translated document now displayed via the user's Internet browser 240 is in the same format as the pre-translated document. The translated document has the same indentions, carriage returns and margins. All embedded images, including drawings and pictures are in the same locations in the translated text as they were in the pre-translated text. After the translated text is displayed by the user's Internet browser 240, the method ends at step 490.

As described herein, a method and system are provided via an application programming interface for efficiently submitting richly-formatted text to a remote server for translation while maintaining formatting and images in their pre-translated format style and positioning. It will be apparent to those skilled in the art that various modifications or variations can be made in the present invention without departing from the scope or spirit of the invention. Other embodiments of the invention will be apparent to those skilled in the art from consideration of the specification and practice of the invention disclosed herein. It is intended that this specification be considered as exemplary only where the true scope and the spirit of the invention are indicated by the following claims.

We claim:

1. A method for submitting a document for translation services, comprising the steps of:
receiving a pre-translated document requiring translation from a first language to a second language;
selecting a translation service from a list of services for translating the pre-translated document from the first language to the second language;
requesting an identification for the selected translation service;
saving the pre-translated document, including any non-text entries from the pre-translated document to a temporary storage medium;
creating a saved document from the pre-translated document in a format for submitting to the selected translation service, the saved document including the formatting of the pre-translated document and including paths to the non-text entries saved in the temporary storage medium; and
submitting the saved document to the selected translation service via the identification for the selected translation service.

2. The method of claim 1, further comprising the steps of:
at the selected translation service, creating a translated document by translating the saved document from the first language to the second language;
receiving the translated document from the selected translation service; and
displaying the translated document.

3. The method of claim 2, wherein the step of displaying the translated document further comprises the steps of:
using the paths to the non-text entries saved in the temporary storage medium to call the non-text entries; and
displaying the translated document with the non-text entries and formatting of the pre-translated document.

4. The method of claim 1, wherein the step of submitting the saved document to the selected translation service, further comprises:
sending the saved document to the selected translation service at a remote translation server via a distributed computing environment.

5. The method of claim 1, prior to the step of selecting a translation service from the list of translation services, further comprising the step of:
receiving a list of translation services; and
maintaining the list of translation services in a system registry.

6. The method of claim 1, wherein the step of requesting an identification for the selected translation service includes the steps of:
requesting a uniform resource locator (URL) for the selected translation service, including sending an HTTP GET request for the URL.

7. The method of claim 1, wherein the step of creating a saved document, further comprises the step of:
saving the pre-translated document in HTML format, including HTML tags defining the formatting of the pre-translated document and HTML tags pointing to the non-text entries saved in the temporary storage medium.

8. The method of claim 1, wherein the step of submitting the saved document to the selected translation service, further comprises the step of:
sending to the selected translation service an HTTP POST request containing parameters associated with the translation service and containing the saved document.

9. The method of claim 8, wherein the step of sending to the selected translation service an HTTP POST request, further comprises the step of:
sending the HTTP POST request via an Internet browser across a distributed computing environment whereby the selected translation service is resident in a remote translation server.

10. A method for submitting a richly-formatted document for translation processing, comprising the steps of:
receiving a pre-translated document requiring translation from a first language to a second language;
receiving a list of translation services for translating a document from a first language to a second language;
selecting a translation service from the list of translation services;
requesting an identification for the selected translation service;
saving the pre-translated document, including text entries, non-text entries, and formatting in the document, to a temporary storage medium;
saving the pre-translated document as an HTML document, including saving paths from the HTML document to the non-text entries in the pre-translated document saved in the temporary storage medium;
sending the HTML document to the selected translation service via the identification for the selected translation service;
at the translation service, translating the HTML document from the first language to the second language;
receiving the translated HTML document from the selected translation service; and
displaying the translated HTML document.

11. The method of claim 10, wherein the step of displaying the translated HTML document further comprises the steps of:
using the paths to the non-text entries saved in the translated HTML document to call the non-text entries and formatting; and
displaying the translated HTML document with the non-text entries and formatting of the pre-translated document.

12. A method of communicating between a client process and a server process in a distributed processing system for providing remote processing, comprising the steps of:
issuing, by the client process, an HTTP GET request call having a plurality of call parameters, comprising a translation service identifier, a “from” language identifier and a “to” language identifier;
receiving, by a first server process, the HTTP GET request call and parsing the call to retrieve the parameters;
issuing, by the first server process, an HTTP GET request acknowledgement having a uniform resource locator (URL) of a second server process;
issuing, by the client process, an HTTP POST request call having a plurality of call parameters comprising a remote processing service provider identifier, a user interface language identifier, a processing service identifier, and further comprising a data body including an HTML formatted document requiring remote processing including tags for document formatting and tags linking the HTML formatted document to non-text images saved to a temporary storage medium, the HTML formatted document requiring processing according to the processing service identifier;
receiving, by the second server process, the HTTP POST request call and parsing the call to retrieve the parameters; and
issuing, by the second server process, an HTTP POST request acknowledgement having a plurality of acknowledgement parameters comprising a user interface language identifier, a processing service identifier, and the HTML formatted document processed according to the processing service identifier and represented in HTML format.

13. The method of claim 12, wherein:
the remote processing service provider identifier includes a translation service identifier;
the processing service identifier includes a “from” language identifier and a “to” language identifier; and
the processed HTML document includes the HTML formatted document translated from the “from” language to the “to” language.

14. A system for submitting an originally-formatted document to a remote translation service, comprising:
a word processing module operative,
to request from a redirection server a URL of a translation server;
to receive from the redirection server the URL;
to save an original document requiring translation from a first language to a second language, such that non-text entries and formatting of the original document are saved to a temporary storage medium, and such that the saved document includes paths to the non-text entries and formatting saved to the temporary storage medium;
an Internet browser module operative,
to receive the saved document from the word processing module;
to send the saved document to a remote translation server via a distributed computing environment;
to receive a translation of the saved document from the remote translation server;
to display the translation of the saved document, including a display of the non-text entries and formatting from the original document in the translation of the saved document; and
the remote translation server operative,
to receive from the Internet browser module the saved document;
to translate the saved document; and
to return the translation of the saved document to the Internet browser module.

15. The system of claim 14, wherein:
the remote redirector server is operative,
to receive service and language parameters from the word processing module; and
to return the identification of the remote translation server to the word processing module.

16. The system of claim 14, whereby the word processing module is further operative
to retrieve a list of translation services from an operating system registry; and
to display the list of translation services.

17. A computer-readable medium having stored thereon computer-executable instructions for submitting a document for translation services, said instructions for performing steps comprising:
receiving a pre-translated document requiring translation from a first language to a second language;
selecting a translation service from a list of services for translating the pre-translated document from the first language to the second language;
requesting an identification for the selected translation service;
saving the pre-translated document, including any non-text entries from the pre-translated document to a temporary storage medium;
creating a saved document from the pre-translated document in a format for submitting to the selected translation service, the saved document including the formatting of the pre-translated document and including paths to the non-text entries saved in the temporary storage medium; and
submitting the saved document to the selected translation service via the identification for the selected translation service.

18. The computer-readable medium of claim 17 having further computer-executable instructions for performing the steps of:
receiving a translated document from the selected translation service; and
displaying the translated document.

19. The computer-readable medium of claim 18 having further computer-executable instructions wherein the step of displaying the translated document further comprises the steps of:
using the paths to the non-text entries saved in the temporary storage medium to call the non-text entries; and
displaying the translated document with the non-text entries and formatting of the pre-translated document.

20. The computer-readable medium of claim 17 having further computer-executable instructions wherein the step of submitting the saved document to the selected translation service further comprises the step of:
sending the saved document to the selected translation service at a remote translation server via a distributed computing environment.

21. The computer-readable medium of claim 17 having further computer-executable instructions wherein the step of requesting an identification for the selected translation service further comprises the step of:
requesting a uniform resource locator (URL) for the selected translation service, including sending an HTTP GET request for the URL.

22. The computer-readable medium of claim 17 having further computer-executable instructions wherein the step of submitting the saved document to the selected translation service further comprises the step of:
sending to the selected translation service an HTTP POST request containing parameters associated with the translation service and containing the saved document.

23. The computer-readable medium of claim 17 having further computer-executable instructions wherein the step of sending to the selected translation service an HTTP POST request further comprises the step of:
sending the HTTP POST request via an Internet browser across a distributed computing environment whereby the selected translation service is resident in a remote translation server.
